(19) United States
(12) Patent Application Publication
(10) Pub. No.: US 2009/0205683 A1
(43) Pub. Date: Aug. 20, 2009

(54) Method of Washing Paint Gun

(75) Inventors: Yoshiki Ogata, Saitama (JP); Tatsuya Otoguro, Saitama (JP); Shinichi Araki, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Minato-ku, Tokyo (JP)

(21) Appl. No.: 11/658,786

(22) PCT Filed: Jul. 4, 2006
(86) PCT No.: PCT/JP2006/313640

§ 371 Date: Oct. 14, 2008

(30) Foreign Application Priority Data
Jul. 6, 2005 (JP) 2005-197910

(51) Int. Cl. B08B 9/032

(52) U.S. Cl. 134/22.12

(57) ABSTRACT

A paint gun is washed by adjusting the spray pressure of washing solution, the pressure of atomizing air, and the pressure of the patterning air so that the washing solution sprayed from the paint nozzle is shaped so as to wash the front surface of the paint nozzle.

### BACKGROUND OF THE INVENTION

1. Field of the Invention

The present invention relates to a method of washing a paint gun designed for use in a paint spraying gun.

2. Background Art

In paint guns for spraying paint to form a paint film, it is important to clean the nozzle by washing. In the particular case of changing the type and color of paint, referred to as “color-changing,” the nozzle needs to be washed and the previous paint (old paint) removed to avoid mixing the old paint with new paint. A washing mechanism for a nozzle is provided to the painting apparatus disclosed in Japanese Patent Laid-Open Publication No. 1-262964, for example.

The above-described conventional painting apparatus 100 comprises a paint gun 101, a drive unit 103 mounted on the paint gun 101 by way of a bracket 102, a cleaning body 105 mounted on the drive shaft 104 of the drive unit 103, and a solvent feeder 107 connected to the cleaning body 105 by way of a tube 106, as shown in FIG. 7 hereof.

The cleaning body 105 is moved by using the drive unit 103 after paint spraying has been stopped, and the nozzle 108 is wiped. The nozzle 108 can be cleaned by the solvent fed from the solvent feeder 107.

However, since the cleaning capacity is reduced when the cleaning body 105 becomes soiled, the cleaning body 105 must be frequently washed or exchanged for a new cleaning body, and the cleaning body 105 becomes inconvenient to use.

Also, the size of the painting apparatus 100 in increased because the bracket 102 and drive unit 103 protrude from the paint gun 101.

In view of the above, there is a need for a washing technique in which the cleaning body 105 is not needed and the painting apparatus 100 can be made smaller.

### SUMMARY OF THE INVENTION

According to an aspect of the present invention, there is provided a method for washing a paint gun that sprays paint from the paint nozzle, atomizes the spayed paint with atomizing air, and shapes the spray by using patterning air, which method comprises the steps of: exchanging the paint for washing solution; and adjusting the spray pressure of the washing solution, the pressure of the atomizing air, and the pressure of the patterning air so that the washing solution sprayed from the paint nozzle is shaped so as to wash the front surface of the paint nozzle.

A cleaning body for wiping the spray nozzle is not needed because washing solution is sprayed from the spray nozzle to remove paint. The paint gun can be made smaller because the paint gun does not need to be provided with a cleaning body or the like.

Preferably, the spray pressure of the washing solution is set to the same pressure as the spray pressure of paint during painting, the pressure of patterning air for the washing solution is set to the same pressure as the pressure of patterning air for paint during painting, and the pressure of air for atomizing the washing solution is set to be 1/50 to 1/20 the pressure of atomizing air for paint during painting.

The washing solution can be prevented from flowing back into the atomizing air channel as long as the pressure of air for atomizing the washing solution is 1/50 or higher of the atomized-air pressure for paint used in the painting work.

When the pressure of air for atomizing the washing solution is set to be 1/20 or less the pressure of atomizing air used in painting, a sufficient amount of washing solution makes contact with the front surface of the paint nozzle.

Thus, the washing solution does not flow backward into the atomizing air channel and a sufficient amount of the solution can be assured to strike the front surface of the paint nozzle by setting the pressure of the atomizing air for the washing solution to be 1/50 to 1/20 the pressure of the atomizing air used during painting.

Desirably, the paint is exchanged for the washing solution at the time the paint color is changed.

Downtime for washing is minimized because the paint gun is washed at the same time the paint color is changed. The utilization rate of the paint line can be increased.

### BRIEF DESCRIPTION OF THE DRAWINGS

A preferred embodiment of the present invention will be described in detail below, by way of example only, with reference to the accompanying drawings, in which:

FIG. 1 is a side view of a paint gun mounted on a painting robot;

FIG. 2 is a cross-sectional view of the paint nozzle, which is the main part of the paint gun,

FIG. 3 is a view as seen from arrow 3 of FIG. 1;

FIG. 4 is a diagram illustrating the self-washing effect of the paint gun;

FIGS. 5A to 5F are diagrams illustrating mist patterns that occur when the pressure of patterning air has been varied;

FIGS. 6A to 6C are diagrams comparing the washing results of the front surface of a paint nozzle; and

FIG. 7 is a schematic view of a conventional painting apparatus.

### DETAILED DESCRIPTION

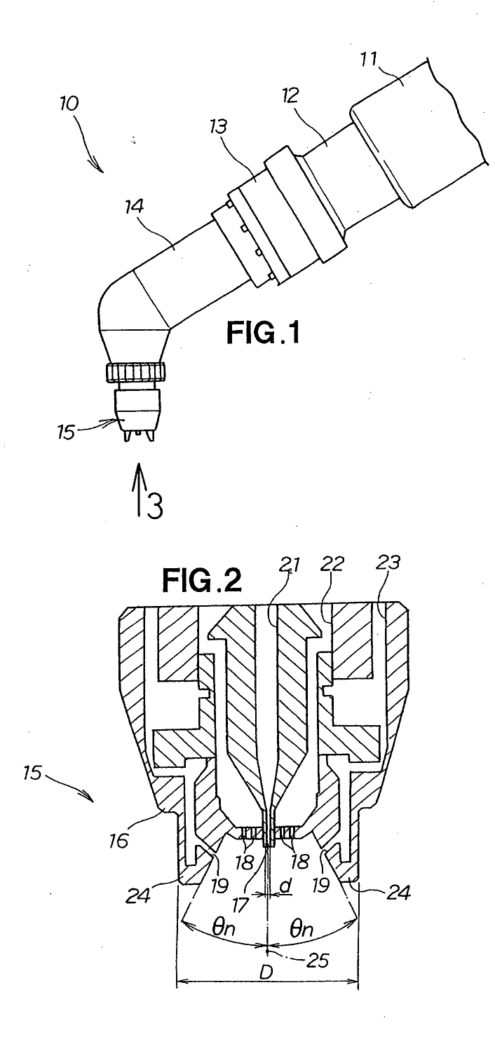

A paint gun 10 comprises a valve unit 13 mounted, for example, on a holder 12 at the distal end of a robot arm 11, a gun main body 14 mounted on the valve unit 13, and a paint nozzle 15 mounted on the distal end of the gun main body 14, as shown in FIG. 1.

The valve unit 13 is a unit that houses a valve for changing the type of paint fed to the paint nozzle 15 and changing the paint to a washing solution.

FIG. 2 provides a description of the details of the paint nozzle 15, which is the main part of the paint gun 10.

A nozzle block 16 comprising the paint nozzle 15 is provided with a spray nozzle 17 that is disposed in the center and that sprays paint, a plurality of atomizing nozzles 18 and 18 that are disposed to both sides the spray nozzle 17 and spray atomizing air, pattern adjustment nozzles 19 and 19 that are disposed on the outside of the atomizing nozzles 18 and 18 and that spray air for forming patterns, a paint channel 21 for feeding paint to the spray nozzle 17, an atomizing air channel 22 for feeding air to the atomizing nozzle 18, and a patterning air channel 23 for feeding air to the pattern adjustment nozzles 19 and 19, as shown in FIG. 2. The pattern adjustment nozzles 19 and 19 are disposed in extension portions 24 and 24 that extend downward from the nozzle block 16. In the diagram, D is the diameter of the circle that encompasses the external peripheral surface of the extension portions 24 and 24, θn and θn are the aperture angles formed by the slopes that pass along the internal peripheral surfaces of the extension portions 24 and 24, and d is the diameter of the spray nozzle 17. The preferred values of these variables are 31 mm for D, 1 mm for d, and 24° for θn. In this case, the diameter of the atomizing nozzle 18 is set to be 0.8 mm, and the diameter of the pattern adjustment nozzle 19 is set to be 1.5 to 1.8 mm.

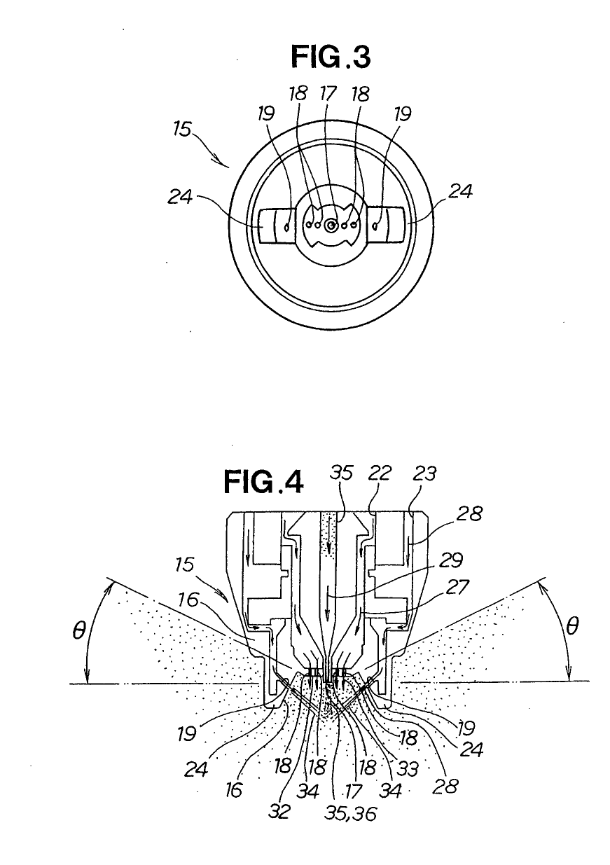

Four atomizing nozzles 18 are disposed to the left and right on the outside of the spray nozzle 17, and the pattern adjustment nozzles 19 and 19 are horizontally disposed in a single line to the left and right on the outside of the atomizing nozzles 18, as shown in FIG. 3.

The effects of the above-described paint nozzle 15 are described below with reference to FIGS. 4 to 6.

The front surface 32 of the paint nozzle 15 is washed as shown in FIG. 4. In other words, atomizing air 33 is fed to the atomizing air channel 22, as indicated by the arrow 27, and the atomizing air 33 is sprayed from the atomizing nozzles 18. Patterning air 34 is simultaneously fed to the patterning air channel 23, as indicated by the arrow 28, and the patterning air 34 is sprayed from the pattern adjustment nozzles 19 and 19. Thinner 35 acting as a washing solution is simultaneously fed to the paint channel 21, as indicated by the arrow 29, and the thinner 35 is sprayed from the spray nozzle 17.

More specifically, air is fed to the atomizing air channel 22 at a pressure of 0.1 kg/cm², washing solution is fed to the paint channel 21 at a pressure of 4 kg/cm², and air at various pressures is fed to the patterning air channel 23. Variations in the resulting spray pattern are described next.

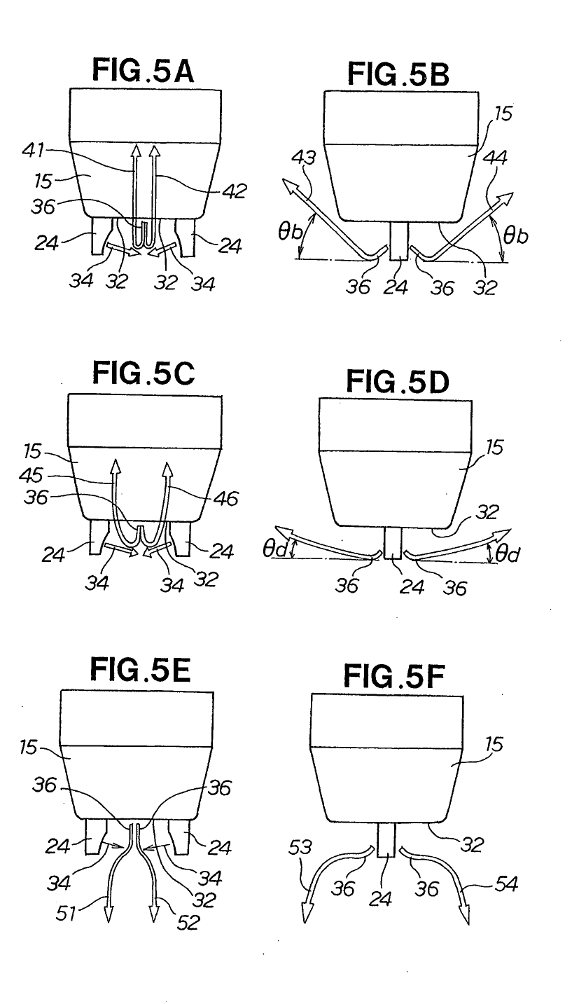

In FIG. 5A, the pressure of the atomizing air is 0.1 kg/cm², the pressure of the washing solution is 4 kg/cm², and the pressure of the patterning air is 4 kg/cm². In this case, the washing solution 36 that is sprayed from the paint nozzle 15 has floated upward in a substantially vertical direction as indicated by the arrows 41 and 42.

FIG. 5B is a view of FIG. 5A as seen from a direction rotated 90°, and the washing solution 36 in the diagram has floated upward an angle of Ob to the horizontal plane, as indicated by the arrows 43 and 44. The angle θb is 30°.

In FIG. 5C, the pressure of the atomizing air is 0.1 kg/cm², the pressure of the washing solution is 4 kg/cm², and the pressure of the patterning air is 3 kg/cm². In this case, the washing solution 36 sprayed from the paint nozzle 15 has floated diagonally upward, as indicated by the arrows 45 and 46.

FIG. 5D is a view of FIG. 5C as seen from a direction rotated 90°, and in the diagram the washing solution 36 has floated upward an angle of θd to the horizontal plane, as indicated by the arrows 47 and 48. The angle θd is 25°.

In FIG. 5E, the pressure of the atomizing air is 0.1 kg/cm², the pressure of the washing solution is 4 kg/cm², and the pressure of the patterning air is 1.5 kg/cm². In this case, the washing solution 36 sprayed from the paint nozzle 15 has fallen downward without any upward movement, as indicated by the arrows 51 and 52.

FIG. 5F is a view of FIG. 5E as seen from a direction rotated 90°, and in the diagram the washing solution 36 has fallen downward without any upward movement, as indicated by the arrows 53 and 54.

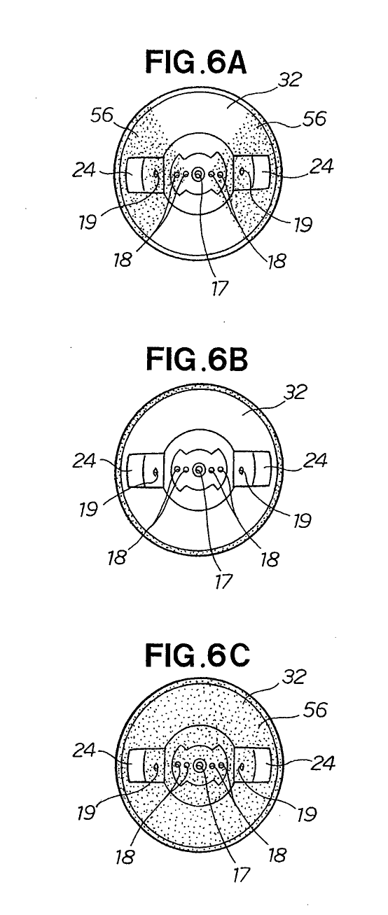

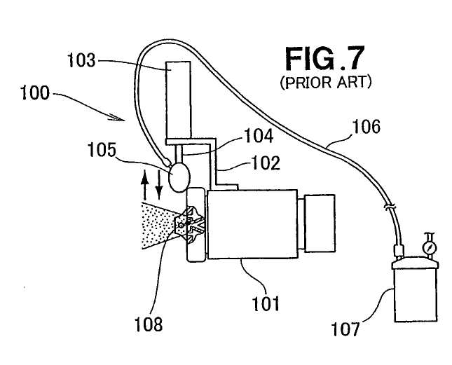

FIG. 6A is a bottom view of FIG. 5A, wherein the paint 56 deposited on the front surface 32 of the paint nozzle is partially left over when the pressure of the patterning air is 4 kg/cm².

FIG. 6B is a bottom view of FIG. 5C, wherein the paint deposited on the front surface 32 of the paint nozzle is entirely removed when the pressure of the patterning air is 3 kg/cm².

FIG. 6C is a bottom view of FIG. SE, the paint 56 deposited on the front surface 32 of the paint nozzle is not removed when the pressure of the patterning air is 1.5 kg/cm².

It is apparent from the description above that the quality of the washing can be controlled by controlling the pressure of the patterning air. In view of the above, the following experiments were performed.

### (Experiment Examples)

TABLE 1

| | Spray pressure Ps | Pressure Pm | Pressure Pp | |
|---|---|---|---|---|
| Experiment | of the washing | of the | of the | |
| No. | solution | atomizing air | patterning air | Evaluation |
| 1 | 4 kg/cm² | 4 kg/cm² | 4 kg/cm² | X |
| 2 | 4 kg/cm² | 4 kg/cm² | 1 kg/cm² | X |
| 3 | 4 kg/cm² | 1 kg/cm² | 3 kg/cm² | X |

In the table, X signifies a poor result.

Beginning from the left in the table are the experiment number, spray pressure of the washing solution, pressure of the atomizing air, pressure of the patterning air, and evaluation. The pressures are indicated as gauge pressures.

Used in the experiments was a paint gun that is used in typical painting work, wherein the spray pressure of the paint is 3 to 4 kg/cm², the atomizing air pressure is 4 kg/cm², and the pressure of the patterning air is 4 kg/cm².

In experiment 1, the settings used in typical painting work were applied unchanged, the spray pressure Ps of the washing solution was 4 kg/cm², the atomizing air pressure Pm was 4 kg/cm², and the pressure of the patterning air Pp was 4 kg/cm². This configuration was evaluated to be poor because a majority of the washing solution jetted forward from the nozzle, and most of the solution did not strike the front surface of the paint nozzle.

In experiment 2, the pressure of the patterning air was considerably reduced. More specifically, the spray pressure Ps of the washing solution was 4 kg/cm², the atomizing air pressure Pm was 4 kg/cm², and the pressure of the patterning air Pp was 1 kg/cm². This configuration was evaluated to be poor because the spray pattern of the washing solution approached that of a cone, but most of the solution did not strike the front surface of the paint nozzle. It was apparent from experiment 2 that adjusting the pressure of the patterning air makes little contribution to washing. In view of the above results, in experiment 3, the pressure of the patterning air was restored to the previous level and the pressure of the atomizing air was reduced. More specifically, the spray pressure Ps of the washing solution was 4 kg/cm², the atomizing air pressure Pm was 4 kg/cm², and the pressure of the patterning air Pp was 3 kg/cm². This configuration was evaluated to be poor because the washing solution reached a portion of the front surface of the paint nozzle, but the washing effect was not considered to be sufficient.

Experiment 3 indicated a possibility that the front surface of the paint nozzle could be self-cleaned by adjusting the pressure of the atomizing air, i.e., reducing the pressure. Therefore, follow-up experiments were carried out using the pressure of atomizing air as parameter.

TABLE 2

| | | | Amount of | |
|---|---|---|---|---|
| | Pressure Pm | | contact on the | |
| Experiment | of the | | front surface of | |
| No. | atomizing air | Pm/P1 | the paint gun | Evaluation |
| 4 | 0.5 | 1/8 | small amount | Δ |
| 5 | 0.2 | 1/20 | adequate | ◯ |
| 6 | 0.1 | 1/40 | adequate | ⊙ |
| 7 | 0.08 | 1/50 | adequate | ◯ |
| 8 | 0.05 | 1/80 | backflow | X |

In the table, X signifies a poor result, Δ is unsatisfactory, ◯ is satisfactory, and ⊙ is excellent.

In experiments 4 to 8, the spray pressure Ps of the washing solution was 4 kg/cm², the pressure of the patterning air Pp was 3 kg/cm², and the pressure Pm of the atomizing air was varied. In the table, P1 is the pressure of the atomizing air used during painting (standard), and is the same pressure as the spray pressure Ps of the washing solution, i.e., 4 kg/cm².

In experiment 4, the pressure Pm of the atomizing air was 0.5 kg/cm². In this case, Pm/P1 was 1/8. In the experiment, a small amount of the washing solution reached the front surface of the paint nozzle. This configuration was evaluated to be unsatisfactory.

In experiment 5, the pressure Pm of the atomizing air was 0.2 kg/cm². In this case, Pm/P1 was 1/20. In the experiment, a sufficient amount of the washing solution reached the front surface of the paint nozzle. This configuration was evaluated to be satisfactory.

In experiment 6, the pressure Pm of the atomizing air was 0.1 kg/cm². In this case, Pm/P1 was 1/40. In the experiment, a more favorable amount of the washing solution reached the front surface of the paint nozzle. This configuration was evaluated to be excellent.

In experiment 7, the pressure Pm of the atomizing air was 0.08 kg/cm². In this case, Pm/P1 was 1/50. In the experiment, a sufficient amount of the washing solution reached the front surface of the paint nozzle. This configuration was evaluated to be satisfactory.

In experiment 8, the pressure Pm of the atomizing air was 0.05 kg/cm². In this case, Pm/P1 was 1/80. In the experiment, a sufficient amount of the washing solution reached the front surface of the paint nozzle, but a problem occurred in which the washing solution flowed back into the atomizing air channel because the pressure of the atomizing air was very low. This configuration was evaluated to be poor.

It was confirmed from the above experiments that the pressure of air for atomizing the washing solution may be set to be 1/50 to 1/20 the pressure of the atomizing air for paint used in painting when the spray pressure of the washing solution is set to the same pressure as the spray pressure of paint used in painting and the pressure of patterning air for the washing solution is set to the same pressure as the pressure of patterning air of paint used in painting.

The washing timing is described next.

In the method of washing the paint gun according to the present invention, the front surface of the paint nozzle can be washed in a short period of time, i.e., 20 seconds per cycle. This period of time does not exceed the time required to wash the paint line, i.e., the time required to wash the inside of the pipes, which must always be performed in accompaniment with a color change.

In view of the above, the paint gun is preferably washed at the time the paint color is changed. Downtime for washing is minimized because the paint gun is washed at the same time as the paint color is changed. The utilization rate of the paint line can be increased.

As described above, the present invention is effective as a method of washing a paint gun and is intended for use in a paint gun for spraying paint, in which paint is sprayed from a paint nozzle, the spayed paint is atomized with atomizing air, and the spray is shaped by using patterning air.

What is claimed is:

1. A method for washing a paint gun that sprays paint from the paint nozzle, atomizes the spayed paint with atomizing air, and adjusts the shape of the spray by using patterning air, said method comprising the steps of:
exchanging the paint for washing solution, and
adjusting the spray pressure of the washing solution, the pressure of the atomizing air, and the pressure of the patterning air so that the washing solution sprayed from the paint nozzle is shaped so as to wash the front surface of the paint nozzle.

2. The method of claim 1, wherein the spray pressure of the washing solution is set to the same pressure as the spray pressure of paint during painting, the pressure of patterning air for the washing solution is set to the same pressure as the pressure of patterning air for paint during painting, and the pressure of air for atomizing the washing solution is set to be 1/50 to 1/20 the pressure of atomizing air for paint during painting.

3. The method of claim 1, wherein paint is exchanged for the washing solution at the time the paint color is changed.
